(19) United States
(12) Patent Application Publication
(10) Pub. No.: US 2005/0119764 A1
(43) Pub. Date: Jun. 2, 2005

(54) Suite of configurable products which can be configured during fitting, configuration tool and configuration process for such products

(75) Inventors: Christian Martin, Formerie (FR); Matthieu Martin, Neufchatel en Bray (FR)

Correspondence Address: YOUNG & THOMPSON, 745 SOUTH 23RD STREET, 2ND FLOOR, ARLINGTON, VA, 22202, US

(73) Assignee: Celec Conception Electronique En Abrege Celec, Neufchatel En Bray (FR)

(21) Appl. No.: 10/508,613

(22) PCT Filed: Mar. 20, 2003
(86) PCT No.: PCT/EP03/03128

(30) Foreign Application Priority Data
Mar. 28, 2002 (FR) 02/03938

(51) Int. Cl. G05B 15/00; G05B 13/02

(52) U.S. Cl. 700/1; 700/28

(57) ABSTRACT

The present invention relates to a suite of configurable products which can be configured during fitting. It also relates to a configuration tool tailored to this suite of configurable products. It relates finally to a configuration process for such products. A configuration tool (19) linked by an infrared channel (18) for communicating configuration words initially recorded in a memory (34), and selected by a keypad (23) performs the loading of the configuration words into the memory (6) of a control circuit (1) equipped with a microcontroller (2) executing a program for configuring a configurable product, such as a sanitary ware during the on-site fitting thereof. Application to a suite of sanitary ware products.

The present invention relates to a suite of configurable products which can be configured during fitting. It also relates to a configuration tool tailored to this suite of configurable products. It relates finally to a configuration process for such products.

In the state of the art, products are known which are equipped with means of control of their operation and which also comprise several facilities such as actuators or detectors which, in cooperation with the control means, execute a particular service according to the program prerecorded in the control means. Such a control means can be built around a microprogrammed microcontroller.

In the state of the art, it is already known to fit such a product into the service environment in which it has to work, and to apply learning thereto, for example by enabling an acknowledge switch in a learning phase and by executing a certain number of operations with the aid of which the microcontroller configures and/or adjusts the actuators and/or the detectors with which it cooperates so as to tailor its functioning to its environment. Such a technique is quite satisfactory.

However, configurable products such as these frequently form part of a suite of products. Several products of the suite then share mutually common facilities. In order to reduce the manufacturing cost, on the one hand, and the difficulty of fitting, on the other hand, it is desirable to achieve standardization of such devices or products.

This is especially the case in respect of a suite of so-called sanitary ware products which all comprise:
an infrared presence detector whose range in particular must be tailored within the premises where the product is mounted before being usable in an acceptable manner;
at least one electrovalve making it possible to control a wash stream of the sanitary ware on which the configurable product is mounted;
a control circuit making it possible in particular to trigger a wash stream periodically.

Such a suite of configurable products for controlling sanitary wares can thus comprise:
wash-hand basins;
all or nothing presence detectors;
time-delay showers;
standard urinals;
urinals with prewash;
toilets;
hand dryers;
soap dispensers.

In the state of the art, each component of each product of the suite is regarded as alone in relation to the product, and not as a member of a suite of products. Particularly, distinct methods of configuration are envisaged which make fitting difficult. It is an aim of the present invention to propose a suite of products which can be configured without difficulty during fitting.

Specifically, the present invention relates to a suite of configurable products which can be configured during fitting, characterized in that each product comprises:
a microcontroller microprogrammed so as to execute at least one service program and one configuration program;
input/output ports connected to a plurality of actuators and/or detectors intended to cooperate with the said service program;
a memory intended to receive a plurality of configuration data during execution of the configuration program;
the service program executing the predetermined service as a function of the said configuration data after the execution of the loading of the said memory.

According to another object, the microcontroller of configurable products of the suite of configurable products of the invention also comprises:
an input/output port connected to a means of linking with an external configuration tool.

The configuration tool mentioned in the definition of the suite of configurable products of the invention allows in particular a fitter, after he has installed the product in its actual service environment, and in particular its hydraulic electric connections, to configure and/or adjust it.

To this end, the invention relates to a configuration tool tailored to a suite of configurable products, characterized in that it comprises:
a microcontroller microprogrammed so as to execute at least one program for configuring a configurable product when the said configuration tool is connected by a tailored communication channel to at least the said configurable product;
a facility for selecting a plurality of configuration data and which is connected to a read or read/write port of the microcontroller;
a means for linking with the means of linking of at least the said configurable product;
a configuration data memory loaded with a configuration data group set, each configuration data group being intended for the configuration of a specified configurable product and/or of a mode of operation (adjustments) of the latter.

The invention relates finally to a process for configuring at least one configurable product of a suite of configurable products.

According to another object, the invention also relates to a process for configuring at least one configurable product of a suite of configurable products by means of a configuration tool, characterized in that it consists:
in loading a memory of configuration data groups, each data group specifying the configuration and/or the adjustment of at least one configurable product of the suite of configurable products;
in connecting by a suitable communication channel the means of linking of the said configuration tool and of at least the said configurable product;
in selecting on a selection facility of the said configuration tool at least one group of configuration data specifying the configuration and/or the adjustment of the said configurable product;
in response, on the said configurable product, in loading the said group of configuration data into the configuration data memory of the said configurable product.

Other advantages and characteristics of the present invention will be better understood with the aid of the description and of the appended drawings in which:

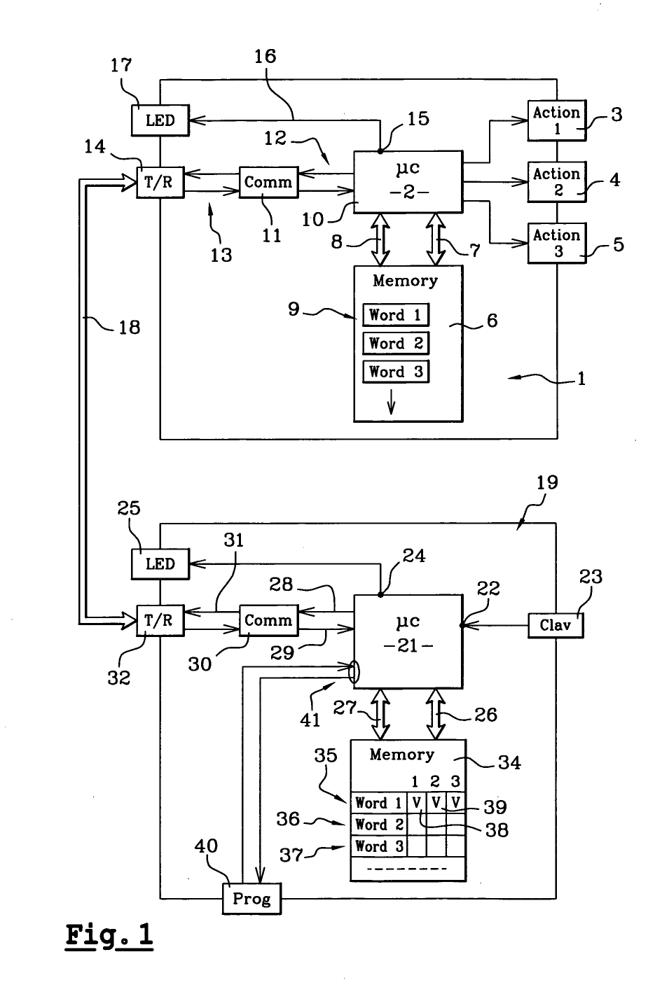

FIG. 1 is a block diagram representing a configurable product in relation to a configuration tool according to a preferred implementation of the invention;

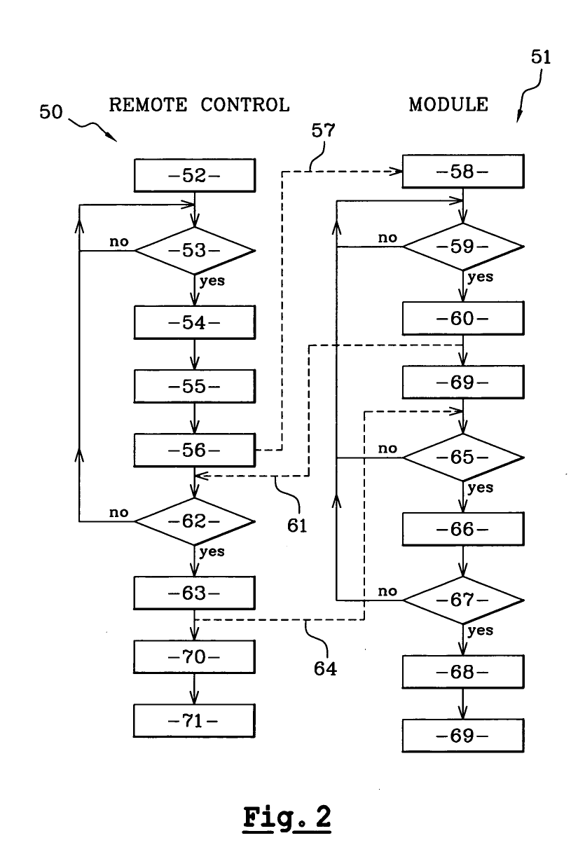

FIG. 2 is a flowchart of two parallel procedures executed in the configuration process of the present invention;

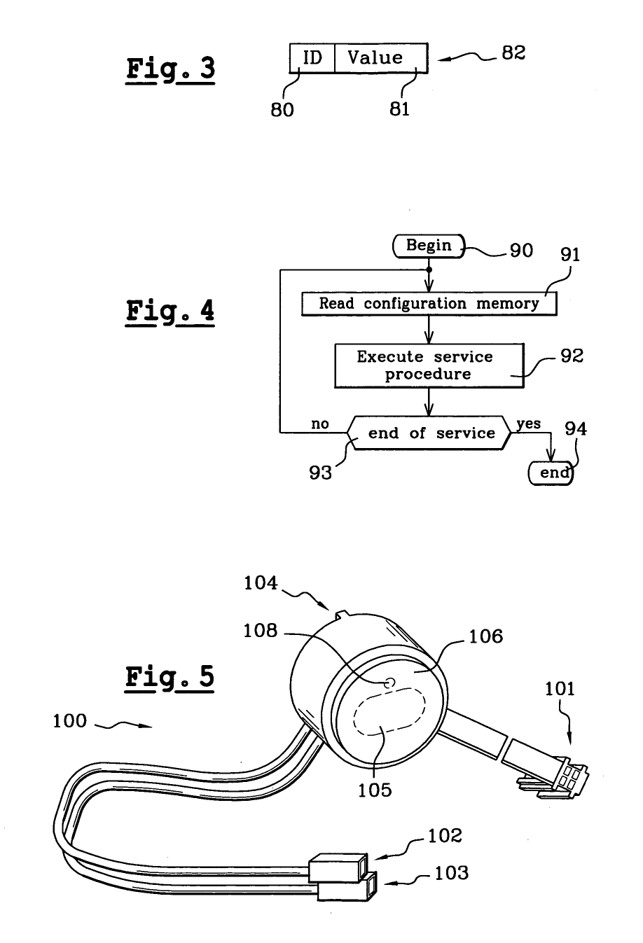

FIG. 3 is a diagram representing the structure of a configuration word;

FIG. 4 is a flowchart representing the operation of a configurable product according to the invention once configuration has been performed;

FIG. 5 represents a standard module intended for a suite of configurable sanitary ware products according to the invention in a particular application.

Represented in FIG. 1 is a block diagram of a configurable product connected with the configuration tool of the invention.

The configurable product 1 essentially comprises a microprogrammable microcontroller 2 which essentially contains a configuration program and a service program. The microcontroller 2 cooperates via input/output ports with actuators and/or detectors 3, 4, 5. The actuators and detectors 3, 4, 5 are limited in number only by the processing capabilities of the microcontroller 2. This arrangement is conventionally encountered in configurable products of the state of the art.

The actuators make it possible to apply actions as a function of the service program recorded in the microcontroller, while the detectors make it possible, as a function of the environment and/or of command(s) from the user, to execute the phases of the program prerecorded in the microcontroller as will be explained later.

The configurable product of the invention comprises a memory 6 intended to receive a plurality of configuration data during the execution of the configuration program recorded in the microcontroller 2.

The configuration data memory 6 is connected to the microcontroller by way of a data bus 7 and an address bus 8, as is known, and comprises a plurality of addresses 9 in which a plurality of words such as WORD1, WORD2, WORD3 are recorded at specified places or addresses.

The microcontroller 2 finally comprises, in one embodiment, an output port 15 connected by a link 16 to a display module 17 comprising especially, in a particular mode, a light emitting diode intended, when it is lit, to indicate that the configurable product is in the actual configuration phase, this diode being a so-called state diode.

Represented in FIG. 5 is a standard module intended for a suite of configurable products according to the invention in a particular application. In the suite of this application, the configurable products consist of:
wash-hand basins;
all or nothing presence detectors;
time-delay showers;
standard urinals;
urinals with prewash;
toilets;
hand dryers; and/or
soap dispensers.

All these products comprise at least one infrared presence detector 105 and one light-emitting diode 108, mounted on the front face of the module 100 of FIG. 5, serving as indication of state of its controller, and hence for this purpose visible from “outside”.

By way of actuator, of the type of the actuators 3-5 of the programmable product of FIG. 1, the modules 100 cooperate with an electrovalve supplied through two wires furnished with terminal strips 102 and 103 which control its state of opening and of closing, so as to control for example the intake of water into the sanitary ware equipped therewith.

The light-emitting diode 108 is controlled by a microcontroller, such as the microcontroller 2, and it is lit when the microcontroller 2 detects the presence of a user in the field of radiation or of detection of the infrared detector 105.

The module 100 next comprises an electrical supply connector 101.

It also comprises, on its rear part, a lug 104 which makes it possible to pinpoint the position of the light-emitting diode in such a way as to place it “high up” so that the light-emitting diode 106 is in a zone which is visible in the configurable product of the invention, in particular by the product fitter.

In all the products of the suite of configurable products, the configuration parameters are in particular the following:
the infrared detection range;
the delay in the turning on of the function such as the opening of the tap by the electrovalve;
the turning off or timing out upon the turning off of the electrovalve;
a safety delay duration upon the opening or the closing of the electrovalve;
a manual turning off in binary or boolean form;
a duration of the stream or wash flow rate;
a duration of the stream or prewash flow rate; and/or
an automatic wash period.

When fitting the sanitary ware, the fitter places the microcontroller 2 of the control device mounted in the sanitary ware in a first mode of adjustment of the range of detection of presence of a user of the sanitary ware.

In this mode of adjustment, the microcontroller 2 comprises a means of detection of first mode of adjustment which cooperates with a means of control of the turning on and turning off of the state diode 17 (FIG. 1) or 108 (FIG. 5). It is then possible to execute the phase of adjustment of the range of triggering of the water flow or flow rate by causing the flashing of the state diode 108, visible to the fitter, and to execute the first mode of programming.

To this end, the fitter then applies his hand against the face in which the infrared presence detector 105 is mounted. The means of detection of first mode of adjustment places the microcontroller 2 in a phase of adjustment of the range of triggering of the water flow by causing the state diode 108 to flash.

After a predetermined duration T1, of for example ten seconds, the microcontroller 2 executes the recording of a detection value VD0 emanating from the infrared presence detector 105, which value VD0 it uses as minimum presence distance and as value for triggering the adjustment of triggering distance.

To indicate to the fitter that the distance VD0 has been acquired, and recorded in a suitable address of the memory 6, the microcontroller 2 places the state diode 108 in a constant illumination for a duration T1 of for example five seconds.

During this time, the fitter moves his hand, away from the face of the configurable product 100 where the infrared presence detector 108 is located, so as to place it in the desired presence detection position. He then keeps his hand in position for a few moments, waiting for the controller 2 of the configurable product to acquire the detection value VD1 emanating from the infrared presence detector 105, which value VD1 it uses as minimum presence distance.

To indicate to the fitter that the distance VD1 has been acquired, and recorded in a suitable address of the memory 6, the microcontroller 2 places the state diode 108 in a flashing state for a duration T2, of for example five seconds, and then, at the end of this acknowledgement duration T2, the controller 2 places the state diode 108 in a state of constant illumination, marking the end of the procedure for adjusting the presence detection range.

In another embodiment, which is not exclusive of the previous one, after having mounted the control device incorporating the circuit 1 of FIG. 1, in a sanitary ware furnished with an electrovalve, the microcontroller 2 executing the configuration program described previously also executes a sequence making it possible to adjust a value chosen from a predetermined set of values:
either of discontinuous values, such as the succession {1, 3, 8, 15, 25};
or of continuous values within a predetermined span for example of integer values lying between a minimum value, 1 for example, and a maximum value 255, for example.

In an exemplary embodiment, the microcontroller 2 is equipped with a means for detecting a cutoff of the supply to the electrovalve which makes it possible to instigate the execution of a software counter which provides, during the count initiated by the detection of the cutoff of the supply to the electrovalve, an incremental value Xi which makes it possible:
either to sequentially traverse a table of values recorded in memory 6 containing the succession of discontinuous values {1, 3, 8, 15, 25};
or to serve directly as value chosen from a predetermined span for example of integer values lying between a minimum value, 1 for example, and a maximum value, 255 for example.

The configuration program executed by the microcontroller 2 places, as soon as the count begins, the state diode in a flashing state so that the fitter can mentally count the interval in which he has progressed the counting of a continuous value Xi or of the address in the table of predetermined values. The fitter then reconnects the electrovalve. The means for detecting a cutoff of the supply to the electrovalve then detects the transition of voltage on its voltage measuring input, and stops the counter at the value Xn. The value Xn is then:
either used by the configuration program to write to an address of the memory 6 the value addressed in the span of predetermined discontinuous values such as {1, 3, 8, 15, 25};
or used directly by the configuration program to write to an address of the memory 6 the value Xn as recorded value of the programmed parameter.

Subsequently, the service program executed by the microcontroller 9 will use the value recorded at the said address of the memory 6 as adjustment parameter.

According to another object of the invention, coming back to the arrangement of FIG. 1, the microcontroller 2 also comprises an input/output port 10 connected by a bidirectional link 12 to a communication management circuit 11 which is itself connected by a bidirectional link 13 to a transmit/receive module 14 connected to a channel 18 for linking with the configuration tool proper 19.

The configurable tool 19 comprises a microcontroller 21. A configuration program which is tailored to carry out in cooperation with at least one configurable product, such as the product 1, the configuring of the configurable product, is kept recorded by the microcontroller 21.

To this end, the microcontroller 21 comprises a data bus 26 and an address bus 27 which are connected in particular to a configuration data group memory specifying the configuration and/or the adjustment of the configurable product 1 when it is connected by the linking channel 18 to the configuration tool 19.

The microcontroller 21 then comprises an input/output port 28 connected by a bidirectional link 29 to a communication device 30, connected by a bidirectional link to a transmit/receive module 32 tailored for exchanging communications over the linking channel 18.

The microcontroller 21 then comprises an input/output port which is connected to a facility for selection of at least one data group specifying the configuration and/or the adjustment of the configurable product 1 which is communicating via the linking channel 18 with the configuration tool 19.

In a particular embodiment, the selection facility comprises a keypad 23 which is equipped with a plurality of preprogrammed function keys and which is connected to a read port 22 of the microcontroller furnished with a well known resource for decoding the keypad.

The selection facility, here consisting of the keypad 23, makes it possible to address, through the intermediary of the address bus 27, a group of words in the memory 34 connected to the said address bus 27 and data bus 26.

The memory 34 having previously been loaded with groups of words such as the groups of words 35, 36, 37 . . . , each group of words comprising a plurality of words such as the words 38 or 39.

When the configuration program recorded in the microcontroller detects the depressing of a particular key of the keypad 23, it addresses a group of words 36 and, as the case may be a particular value 38 associated with the key.

The group of words or the word is then sent by the communication means to the transmit/receive module 32, then transferred to the linking channel 18, then detected on the transmitter/receiver module 14 of the configurable product 1. The detected group of words is then transferred by way of the communication facility 11 and the link 12 to the microcontroller 2, then loaded by the data bus 7 at the suitable address indicated by the configuration program recorded in the microcontroller 2. The group of words is loaded at the address indicated on the address bus 8 in the stack of configuration words 9 of the memory 6.

The configuration tool 19 finally comprises a means of display of the state and/or of the selection of the word or of the group of configuration words which was made with the aid of the keypad 23 which is connected, for this purpose, by an output port 24 of the microcontroller 21.

In a particular implementation, display is carried out by a straightforward light-emitting diode 25.

In another embodiment, it can be carried out by a plurality of diodes just one of which displays at a time in front of the indication of the configuration selected on the keypad 23.

In another embodiment, the selection facility can be conjoined between a particular means of selection and a display means such as a touch screen or an “Organizer” type pad.

The configuration facility 19 can finally comprise a connection 40 intended to allow linkage between the configuration tool and a computer for loading the memory 34.

For this purpose, the programming connector 40 is connected in a known manner by an input/output port 41 of the microcontroller 21.

When, the programming tool 19 has been manufactured in the factory, the programming tool is embodied in a portable box with its own supply, in particular from batteries, and it is connected by the connector 40, for example, to the serial socket of a computer for programming configuration tools. By virtue of a previously produced program, loaded with the series of the groups of configuration words 35, 36, 37 corresponding to the entire suite of configurable products such as the product 1, the computer downloads the configuration tool.

At the end of the downloading operation, the programming tool, embodied in its portable box, is disconnected from the serial link through the socket 40 and it can then be used by the fitter subsequently for all the configurable products of the suite of configurable products of the invention.

The main steps of the configuration process of the invention will now be described.

In a first step of the process of the invention, the loading of a memory with configuration data groups is carried out, each data group specifying the configuration or the adjustment of the configurable product.

It is clear that this memory is that which is disposed in a configuration tool as explained with the aid of FIG. 1.

In a second step, the means of linking of the configuration tool are connected by a suitable communication channel such as the channel 18, to at least one configurable product of the suite of configurable products of the invention.

In one embodiment, it is possible to carry out a single programming of a series of identical configurable products, if they are placed in an environment representative of reality.

Such a solution can be applied when several products can be linked by the same linking channel 18 and when one and the same group of words or of configuration data can be used to configure them.

It is noted that the configuring of a configurable product of a suite of configurable products can be carried out by selecting one or more actuators or detectors such as the actuators and detectors 3, 4 and 5 of the product 1 of FIG. 1, but also by indicating a suite of operating values which is associated with a sensor, or is associated with a particular actuator.

Therefore, throughout the present patent application, the term configuration will be understood to mean both the selecting of a particular facility of the product or the adjusting of its operation.

Likewise, configuration is actually envisaged during-fitting, but it may also be repeated during the maintenance or repair procedure, subsequently during the life of the configurable product of the suite of configurable products of the invention.

In a third step of the configuration process of the invention, the selecting on the selection-facility of the configuration tool for a group of configuration data specifying the configuration and/or the adjustment of the configurable product 1 is carried out.

When the microcontroller 2 of the configurable product 1 is connected by the linking channel 18 to the configuration tool 19, the microcontroller 2 executes its own configuration priming program so as to load the configuration word or words into the stack of configuration words 9 of the memory 6.

It will be noted that the microcontroller 2 preferably consists of the same microcontroller as that which executes the service program which serves the actuators and detectors 3-5.

Therefore, it is also possible for the memory 6 containing the stack of configuration and/or adjustment words 9 to serve as data memory and as work memory for the utilization of the configurable product 1.

Coming back to FIG. 1, it is noted that the type of link envisaged may be unrestricted. In a preferred embodiment, the transmit/receive modules 14 of the configurable product and 32 of the configuration tool 19 consist of infrared transmitter/receiver modules, for example of the iRDA type.

In other embodiments, the transmit/receive devices consist of wire connection sockets, the linking channel 18 then consisting of a data bus.

In another embodiment, the transmit/receive module 14 or 32 is embodied in radiofrequency form, for example according to the “BLUETOOTH” standard (registered trademark).

Represented in FIG. 2 is the flowchart of the part of the process of the invention which relates more specifically to the exchanging of data over the channel 18.

The flowchart of FIG. 2 is composed of two halves 50 and 51, the left half 50 being associated with the configuration program loaded into the microcontroller 21 of the configuration tool 19, while the right half 51 is associated with the program recorded in the microcontroller 2 of the configurable product 1.

In a startup step 52, the remote control such as the configuration tool 19 of FIG. 1, is placed in operating state for example by depressing the on/off key.

Control then passes to a test 53 of pressing of a key of the keypad 23 of the configuration tool 19. As long as a key has not been depressed, control returns to the beginning of the test 53.

When the key press test is positive, control passes to a step 54 of preloading of the configuration word to be dispatched corresponding to the function selected on the key of the keypad 23.

Control then passes to a step 55 of displaying or of turning on the light-emitting diode 25 of the configuration tool 19.

Then, control passes to step 56 in the course of which the communication circuit 30 generates the startup bit bound for the configurable product undergoing configuration.

For this purpose, the data item consisting of the startup bit is sent according to the flow 57 to a step 58 of startup of the configuration program recorded in the microcontroller 2 of the configurable product 1. Control then passes to the test of receipt of a data item originating from the configuration tool 19 in a test 59, as long as the test is not activated, control returns to the input of the test.

When the test is positive, control passes to a step 60 in the course of which the microcontroller through the intermediary of its communication means 11 generates a confirmation word or data item bound for the communication facility 30 of the configuration tool 19 according to the flow 61.

Control then returns to the procedure 50 in the configuration tool 19 in a test 62 in the course of which confirmation of receipt is awaited from the module.

As long as the confirmation of receipt test is not positive, control returns to the beginning of the test 53 of pressing a key.

When the test 62 of pressing of a key is positive, control, in the procedure 50 passes to a step 63 of production or of transmission of the word preloaded during step 54.

The preloaded word is then sent, according to the flow 64, and control passes to the procedure 51 on the configurable product 1.

A test 65 for detecting if data are received is performed during this test 65 and control returns to the beginning of the receipt of remote control test as long as this test is not positive.

When the test 65 of receipt of data is positive, control of procedure 51 passes to step 66 of storing the data received in a suitable memory of the stack of configuration words 9 of the memory 6.

Control of the procedure 51 passes via a programming correction test 67.

If the test is negative, that is to say if the programming or the recording of data is suitable, by virtue of correct readout of the data in memory, control passes back to the step of, awaiting receipt of words or of data originating from the channel 18 in the step of test 59.

If the programming correction test 67 is suitable, control passes to the next step 68. Step 68 is executed when a step 69 has previously been performed before entry to the data reception test 65, when the microcontroller 2 of the programmable product executes the turning on of the light-emitting diode 17.

In this case, during step 68, on completion of the positive test 67, the light-emitting signalling diode is turned off on the configurable product. Control then passes to an end step 69.

During this time, in the procedure 50 executed in the configuration program of the microcontroller 21 of the configuration tool 19, one passes to a step 70 in which the light-emitting diode 25 is turned off so as to indicate the end of the procedure for downloading the selected configuration words or the group of selected configuration words. Control then passes from the procedure 70 to the end step 71.

Represented in FIG. 3 is the configuration of a configuration word 82.

In a particular embodiment, the configuration word comprises a header 80 which indicates the identity of the function concerned from among the set of configurable functions in the configurable products of the suite of configurable products of the invention.

The word 82 then comprises a configuration value proper which can, in particular, be an indication of an adjustment suite such as a range in the case of an infrared detector from among the actuators and the detectors 3-5 of the product, or the duration of timeout of an actuator or of the change of state of the actuator such as one of the actuators 3-5 in the product 1.

Represented in FIG. 4 is a flowchart explaining the service program executed in the microcontroller 2 of the configurable product 1 when configuration has been performed.

In a begin step 90, control executes a reading of the configuration memory during a step 91.

The configuration data are then loaded in a service procedure during a step 92 in the course of which the service procedure makes it possible to carry out the actions on the actuators 3-5 as a function of the detection elements if there are detectors and the control procedure passes from the step 92 to an end of service test step 93.

If the end of service test 93 is negative, control returns to the reading 91 of the configuration memory.

If the end of service test 93 is positive, control passes to an end step 94.

Coming back to the preferred embodiment of a suite of configurable products which consists of the eight sanitary ware products described hereinabove, each of the eight preceding words constitutes a configuration data group which is loaded into the memory 34 of the programming tool 19.

The various possible values are loaded for each word such as the word 35 into one of the values 38 or 39.

As a result of this, as a function of the usage environments, the fitter can load a group of configuration data which are suitable for the operation of the programmable appliance fitted.

Some of the appliances do not need all the hereinabove aforesaid configuration words and, in that case, their value is indicative of a non-connection.

A particular embodiment will now be described of the process for configuring a configurable product consisting of a device for controlling the operation of a sanitary ware, which uses both the manual programming described hereinabove and the remote programming described with the aid of the remote control or configuration tool 19, the sanitary ware and/or its control device forming part of the hereinabove described suite of configurable products.

In this embodiment, the remote control or configuration tool 19 is, as described previously, used when fitting the sanitary ware. The fitter having pressed a suitable function key, the configuration tool 19 places the microcontroller 2 of the control device mounted in the sanitary ware in a first mode of adjustment of the range of detection of presence of a user of the sanitary ware.

In this embodiment, it is then possible to execute the phase of adjustment of the range of triggering of the water flow rate by causing the flashing of the state diode 108, visible by the fitter, and to execute the first mode of programming, the description of which may be referred to hereinabove.

Likewise, it is also possible to mount the control device incorporating the circuit 1 of FIG. 1, in a sanitary ware furnished with an electrovalve, the user having pressed a suitable function key of the configuration tool or remote control 19, the configuration tool 19 places the microcontroller 2 of the control device mounted in the sanitary ware in a second mode of adjustment of a value chosen from a predetermined set of values, second mode of programming, the description of which may be referred to herein.

In a concrete case, with the aid of the remote control 19, the fitter has placed the configuration program of the controller 2 in a first mode of adjustment for the selecting of the duration of closure of a bistable electrovalve controlled by the circuit 1 of FIG. 1. The microcontroller 2 equips a control circuit of a wash-hand basin, the opening of whose water tap is controlled by the closing of an electrovalve.

In a first sequence, as explained hereinabove, the fitter adjusts the presence detection range on the presence detector 108 after having placed the microcontroller 2 in the mode of adjustment of the presence detection range. The memory receives a value of presence detection distance DDP which is recorded in a first address of the memory 6 as described hereinabove.

In a second sequence, the fitter with the aid of the remote control 19 places the microcontroller 2 in the mode of programming in the water dispensing duration by interrupting the supply to the electrovalve with which the tap of the wash-hand basin is equipped.

The approaching of the user's hands to the preprogrammed distance from the infrared presence detector triggers the closing of the electrovalve and, therefore, the opening of the flow. The means for detecting cutoff of the supply to the electrovalve then starts at the same time the counter Xi and the slow flashing of the state diode, flashing synchronized with the period of incrementation of the counter Xi. The counter Xi has been preloaded with the minimum value of 5, and each counting interval represents one unit. The fitter having decided to adjust the duration of dispensing over 15 seconds, the counts ten flashes of the state diode and re-enables the electrovalve, the effect of this being to stop the counter at the final value Xn=15 and to record the value Xn=15 in a second address of the memory 6.

When the service program is executed, if a user of the wash-hand basin approaches the presence detector 108 to the distance DDP, the microcontroller 2 transmits via its suitable output port a calibrated pulse which causes the bistable electrovalve to close and the dispensing of water starts.

At the same time, the microcontroller 2 starts a time count which is stopped when the time counter has reached the value Xn=15 recorded at the second aforesaid address of the memory 6. The microcontroller 2 then places a new calibrated pulse on its output port connected to the bistable electrovalve, the effect of this being to open and interrupt the dispensing of water.

1. Suite of configurable products which can be configured during fitting, characterized in that each product comprises:
a microcontroller (2) microprogrammed so as to execute at least one service program and one configuration program;
input/output ports connected to a plurality of actuators and/or detectors (3-5) intended to cooperate with the said service program;
a memory (6) intended to receive a plurality of configuration data during execution of the configuration program; the service program executing the predetermined service as a function of the said configuration data after the execution of the loading of the said memory.

2. Suite of configurable products, in particular for control of sanitary wares of the kind comprising a presence detector with adjustable detection range, according to claim 1, characterized in that the microcontroller (2) of the control device mounted in the sanitary ware is placed in a first mode of adjustment of the range of detection of presence of a user of the sanitary ware, the microcontroller (2) comprising a means of detection of first mode of adjustment which cooperates with a state signalling means (17, FIG. 1; 108, FIG. 5), the means of detection of first mode of adjustment detecting that the fitter is applying his hand against the face in which the infrared presence detector (105) is mounted, then detecting after a duration (T1) that the fitter is moving his hand away from the face of the configurable product (100) where the infrared presence detector (108) is located so as to place it in the desired presence detection position, next that he is now keeping his hand in position for a second duration (T2), waiting for the controller (2) of the configurable product to acquire the detection value (VD1) emanating from the infrared presence detector (105), which value (VD1) it uses as minimum presence distance, acquired, and recorded in a suitable address of the memory (6).

3. Suite of configurable products, in particular for control of sanitary wares of the kind comprising an electrovalve for controlling a sanitary wash flow, according to claim 1 characterized in that the microcontroller (2) of the control device mounted in the sanitary ware is placed in a second mode of adjustment and comprises a means for executing a sequence making it possible to adjust a value chosen from a predetermined set of values:
either of discontinuous values, such as the succession {1, 3, 8, 15, 25};
or of continuous values within a predetermined span for example of integer values lying between a minimum value (1), and a maximum value (“255”);
in particular, the microcontroller (2) being equipped with a means for detecting a cutoff of the supply to the electrovalve which makes it possible to instigate the execution of a software counter which provides, during the count initiated by the detection of the cutoff of the supply to the electrovalve, an incremental value Xi which makes it possible:
either to sequentially traverse a table of values recorded in memory (6) containing the succession of discontinuous values {1, 3, 8, 15, 25};
or to serve directly as value chosen from a predetermined span for example of integer values lying between a minimum value (“1”) and a maximum value (“255”);
the microcontroller (2) comprising a means for placing, as soon as the count begins, a means of signalling of the state of adjustment so that the fitter can mentally count the interval in which he has progressed the counting of a continuous value Xi or of the address in the table of predetermined values; next, the means for detecting a cutoff of the supply to the electrovalve detecting a transition of voltage on its voltage measuring input, stopping the counter at the value Xn:
either used by the configuration program to write to an address of the memory (6) the value addressed in the span of predetermined discontinuous values such as {1, 3, 8, 15, 25};
or used directly by the configuration program to write to an address of the memory (6) the value Xi as recorded value of the programmed parameter.

4. Suite of configurable products according to claim 1, characterized in that the microcontroller (2) of the configurable product comprises an input/output port (10) connected by a bidirectional link (12) to a communication management circuit (11) which is itself connected by a bidirectional link (13) to a transmit/receive module (14) connected to a channel (18) for linking with a configuration tool (19).

5. Suite of configurable products according to claim 4, characterized in that the microcontroller (2) of a configurable product comprises an output port (15) connected by a link (16) to a display module (17) such as a light-emitting diode intended, when it is lit, to indicate that the configurable product is in the actual configuration phase.

6. Configuration tool tailored to a suite of configurable products according to claim 1, characterized in that it comprises:
a microcontroller (21) microprogrammed so as to execute at least one program for configuring a configurable product when the said configuration tool is connected by a tailored communication channel (18) to at least the said configurable product (1);
a facility (23) for selecting a plurality of configuration data and which is connected to a read or read/write port of the microcontroller;
a means (32) for linking with the means of linking (14) of at least the said configurable product (1);
a configuration data memory (34) loaded with a configuration data group set, each configuration data group being intended for the configuration of a specified configurable product and/or of a mode of operation (adjustments) of the latter.

7. Configuration tool according to claim 6, characterized in that the microcontroller (21) comprises an input/output port (28) connected by a bidirectional link (29) to a communication device (30), connected by a bidirectional link to a transmit/receive module (32) tailored for exchanging communications over the linking channel (18).

8. Configuration tool according to claim 7, characterized in that the microcontroller (21) comprises an input/output port (22) which is connected to a facility for selection (23) of at least one data group specifying the configuration and/or the adjustment of the configurable product (1) which is communicating via the linking channel (18) with the configuration tool (19), such as a selection facility comprising a keypad (23) which is equipped with a plurality of preprogrammed function keys and which is connected to the read port (22) of the microcontroller furnished with a resource for decoding the keypad, so that the selection facility addresses, a group of words in the memory (34) connected to an address bus (27) and a data bus (26), the memory (34) having previously been loaded with groups of words (35, 36, 37 . . . , ) each group of words comprising a plurality of words such as the words (38 or 39), so that when the configuration program recorded in the microcontroller detects the depressing of a particular key of the keypad (23), it addresses a group of words (36) and, as the case may be, a particular value (38) associated with the key, the group of words or the word then being sent by the communication means (39) to the transmit/receive module (32), transferred to the linking channel (18), detected on the transmitter/receiver module (14) of the configurable product (1) and transferred to the suitable address indicated by the configuration program recorded in the microcontroller (2) in the stack of configuration words (9) of the memory (6).

9. Configuration tool according to claim 8, characterized in that it comprises a means of display (25) of the state and/or of the selection of the word or of the group of configuration words which was made with the aid of the keypad (23), such as a straightforward light-emitting diode.

10. Configuration tool according to claim 6, characterized in that it comprises a connection (40) intended to allow the linking between the configuration tool and a computer for loading the memory (34).

11. Process for configuring at least one configurable product of a suite of configurable products as is defined according claim 1, characterized in that it consists:
in loading a memory with configuration data groups, each data group specifying the configuration and/or the adjustment of at least one configurable product of the suite of configurable products;
in connecting by a suitable communication channel the means of linking of the said configuration tool and of at least the said configurable product;
in selecting on a selection facility of the said configuration tool at least one group of configuration data specifying the configuration and/or the adjustment of the said configurable product;
in response, on the said configurable product, in loading the said group of configuration data into the configuration data memory of the said configurable product.

12. Process according to claim 11, characterized in that, when the microcontroller (2) of the configurable product (1) is connected by the linking channel (18) to the configuration tool (19), the microcontroller (2) executes its own configuration priming program so as to load the configuration word or words into the stack of configuration words (9) of the memory (6).

13. Process according to claim 11, characterized in that the configuration is initiated in a startup step (52), the remote control (19) having been placed in an operating state.

14. Process according to claim 12, characterized in that it comprises a test (563) of pressing of a key of the keypad (23) of the configuration tool (19), followed by a step (54) of preloading the configuration word to be dispatched corresponding to the function selected on the key of the keypad (23).

15. Process according to claim 14, characterized in that it comprises a step (55) of display or of turning on of the light-emitting diode (25) of the configuration tool (19).

16. Process according to claim 14, characterized in that it comprises a step (56) in the course of which the communication circuit (30) generates a startup bit bound for the configurable product undergoing configuration, so that a step (58) of starting up the configuration program recorded in the microcontroller (2) of the configurable product (1) is executed (57), so that a test (59) of reception of a data item originating from the configuration tool (19) is performed.

17. Process according to claim 15, characterized in that it comprises a step (60) for generating a confirmation word or data item bound for the communication facility (30) of the configuration tool (19), so that a test (62) is performed, in the configuration tool (19), in the course of which confirmation of receipt is awaited from the module, as long as the test of confirmation of receipt is not positive, control returning to the beginning of the test (53) of pressing of a key, and when the test (62) of pressing of a key is positive, control passing to a step (63) of producing or of transmitting the preloaded word, sent (64) to the configurable product (1).

18. Process according to claim 17, characterized in that it comprises a test (65) for detecting if data are received and control returns to the beginning of the test of receipt of remote control as long as this test is not positive, next, when the test (65) of receipt of data is positive, control of the procedure (51) passes to the step (66) of storing the data received in a suitable memory of the stack of configuration words (9) of the memory (6).

19. Process according to claim 18, characterized in that control of the procedure (51) passes via a programming correction test (67), so that if the test is negative, that is to say if the programming or the recording of data is suitable, by virtue of correct readout of the data in memory, control passes back to the step of awaiting receipt of words or of data originating from the channel (18) in the step of the test (59), and if the programming correction test (67) is suitable, control passes to the next step (68).

20. Process according to claim 11, characterized in that it consists in placing the microcontroller (2) of the configurable product in a first mode of adjustment of a continuous operating value, such as the range of detection of presence of a user of a sanitary ware equipped with an infrared presence detector, by sending of a selected configuration word to a configuration tool (19).

21. Process according to claim 19, characterized in that it consists, in placing the microcontroller (2) of the configurable product in a second mode of adjustment of a value selected from a set of discontinuous values or of a continuous value within a specified span, such as a duration of opening of the electrovalve for controlling a wash flow in a sanitary ware furnished with an electrovalve.

22. Process according to claim 10, characterized in that a service program is executed in the microcontroller (2) of the configurable product (1) when configuration has been performed.
